(19) United States
(12) Patent Application Publication
(10) Pub. No.: US 2020/0147631 A1
(43) Pub. Date: May 14, 2020

(54) DISTRIBUTOR LINKAGE

(71) Applicant: Amazonen-Werke H. Dreyer GmbH & Co. KG, Hasbergen (DE)

(72) Inventors: Anna-Gret Borchert, Osnabrück (DE); Timo Klemann, Belm (DE); Christoph Kühn, Osnabrück (DE)

(21) Appl. No.: 16/620,330

(22) PCT Filed: May 17, 2018
(86) PCT No.: PCT/EP2018/062838

§ 371 Date: Dec. 6, 2019

(30) Foreign Application Priority Data
Jun. 7, 2017 (DE) 10 2017 112 498.5
Jun. 30, 2017 (DE) 10 2017 114 637.7

(51) Int. Cl. B05B 15/14; B05B 1/20; A01M 7/00

(52) U.S. Cl. CPC B05B 15/14; A01M 7/0042; A01M 7/0071; B05B 1/20

(57) ABSTRACT

The invention refers to a spraying device (10) for an agricultural sprayer (100), comprising a distributor linkage (12) on which multiple dispensing elements (22) for dispensing a spray liquid are arranged, an active vibration reduction device (24) which is designed to actively reduce vibrations of the distributor linkage (12), and a dispensing quantity controller (26) which is designed to adapt the spray liquid dispensing quantity (AM) of individual, grouped or all of the dispensing elements (22) to vibrations of the distributor linkage (12).

The invention refers to a spraying device for an agricultural sprayer according to the preamble of patent claim 1 and an agricultural sprayer according to the preamble of patent claim 19.

Agricultural sprayers, such as field sprayers, are used to apply pesticides or fertilisers to arable soils or crops. For this purpose, spraying devices usually have a distributor linkage on which several dispensing elements for dispensing a spray liquid are arranged. The distributor linkage usually extends transversely to the direction of travel and can have considerable widths of 50 m or more.

During dispensing spray liquid, the speed of different linkage sections may vary, for example due to cornering, so that the dispensing characteristics of the spraying device must be adapted to achieve uniform dispensing of the spray liquid. References WO 2012/034754 A1 and EP 1 346 637 A1 describe a possibility to adapt the dispensing quantity of the dispensing elements during cornering in such a way that a uniform dispensing of the spray liquid is achieved.

However, it has been found, that the vibrations carried out by the distributor linkage can also lead to a considerable impairment of the dispensing result. The speed differences at the dispensing elements caused by the linkage vibrations ultimately lead to an irregular dispensing of the spray liquid.

To reduce linkage vibrations, references DE 20 2013 011 983 U1 and EP 2 829 177 B1 suggest reducing linkage vibrations by means of an active damping system. In addition, references DE 10 2014 111 090 A1 and DE 10 2015 113 721 A1 provide a possibility of actively absorbing the vibrations of a distributor linkage.

In spite of the use of active damping devices or active absorbing devices to reduce linkage vibrations, the dispensing elements of the corresponding spraying devices continue to have different speeds during operation, so that considerable irregularities in the dispensing of the spraying liquid are still produced. This may be due to the fact that the damping/absorbing device has too slow a response or is not able to completely damp and/or absorb the linkage vibrations for other reasons, in particular due to its principle.

The object underlying the invention is thus to further increase the regularity of the dispensing of a spray liquid by means of a spraying device for an agricultural sprayer.

The object is solved by a spraying device of the type mentioned above, wherein the spraying device comprises a dispensing quantity controller which is designed to adapt the dispensing quantity of spray liquid of individual, grouped or all dispensing elements to vibrations of the distributor linkage.

The invention takes advantage of the fact that a combination of an active 7vibration reduction device and a dispensing quantity controller can considerably increase the regularity of the spray liquid dispensing. The linkage vibrations still existing after the active vibration reduction by the vibration reduction device lead to different speeds at the dispensing elements of the spraying device. These different speeds are compensated by adapting the dispensing quantity by means of the dispensing quantity controller in such a way that the regularity of the sprayed liquid is increased. This ultimately leads to an improvement in the dispensing result and thus to increased yields.

If, for example, the distributor linkage swings backwards while the agricultural sprayer is moving, the absolute speed of the distributor linkage decreases from the linkage centre to the outer areas of the distributor linkage. As a result, such vibrations result in an increasing overdosage of spray liquid with increasing distance from the linkage centre. For example, if the distributor linkage swings forward while the agricultural sprayer is moving, the absolute speed of the distributor linkage increases from the linkage centre to the outer areas of the distributor linkage. As a result, such vibrations result in an increasing underdosage of spray liquid with increasing distance from the linkage centre. Preferably, the dispensing quantity of spray liquid of individual, grouped or all dispensing elements is adapted to the vibrations of the distributor linkage by adapting the dispensing quantity of spray liquid of individual, grouped or all dispensing elements to the different speeds of the distributor linkage or the different speeds of the dispensing elements. By adapting the spray quantity of spray liquid of individual, grouped or all spray elements to the different speeds of the distributor linkage or the different speeds of the spray elements, vibration-related underdosage and overdosage of spray liquid can be effectively compensated. The dispensing elements of a group are arranged along a section of the distributor linkage. The distributor linkage preferably extends transversely to the direction of travel of the agricultural sprayer. In particular, the distributor linkage comprises a first linkage extending in a first lateral direction and a second linkage extending in an opposite second lateral direction.

In a particularly preferred embodiment of the spraying device according to the invention, the active vibration reduction device is designed to actively reduce elastic vibrations of the distributor linkage and/or rigid body vibrations of the distributor linkage. The vibrations of the distributor linkage are caused, for example, by uneven ground and the driving behaviour of the agricultural sprayer. In addition, the distributor linkage has a pronounced elasticity so that, in addition to rigid body vibrations, elastic vibrations also occur in the distributor linkage. The elastic vibrations of the distributor linkage lead to a “jerk” of the distributor linkage. Due to the linkage suspension, a “rigid jerk” is not possible. Therefore, this mode of vibration occurs as elastic vibration. The first natural frequency is usually between 0.7 Hz and 1.0 Hz, the second natural frequency can be around 2.5 Hz, for example. Further natural frequencies are above 3.5 Hz. The rigid body vibrations and/or the elastic vibrations of the distributor linkage can also lead to “yawing” of the distributor linkage. The “rigid yawing” lies in a frequency range up to about 0.4 Hz and is caused by the linkage suspension. In addition, elastic yaw can also occur with a first natural frequency of about 1.5 Hz to 2.0 Hz. Further elastic yaw natural frequencies lie above 3 Hz. When the agricultural sprayer is driving straight ahead, jerking is usually the main mode of vibration. When cornering or driving on headlands, however, yawing can also be the main form of vibration.

In another preferred embodiment of the spraying device according to the invention, the active vibration reduction device is adapted to reduce horizontal and/or vertical linkage vibrations. Preferably, the active vibration reduction device is designed to reduce the amplitude and/or frequency of the horizontal linkage vibrations directed in the direction of travel and counter to the direction of travel. The horizontal linkage vibrations cause an additional relative movement of the dispensing elements parallel to the ground and thus have a considerable influence on dispensing the spray liquid. Since the spray cone of some types of dispensing elements changes with the distance from the dispensing opening of the respective dispensing element, vertical linkage vibrations can also cause irregularities in the dispensing of the spray liquid. Therefore, the active reduction of vertical and/or horizontal linkage vibrations can significantly improve the dispensing result. The distributor linkage is preferably suspended by means of a pendulum suspension, whereby a vertical guidance of the distributor linkage is implemented by means of the pendulum suspension.

In a further development of the spraying device according to the invention, the active vibration reduction device is adapted to actively dampen vibrations of the distributor linkage. If the vibration reduction device is adapted to actively damp the vibrations of the distributor linkage, the vibration reduction device may comprise one or more active damping units whose damping characteristics are adaptable to the respective operating situation. Different active damper types can be used for active damping of the vibrations of the distributor linkage. For example, one or more active dampers are designed as electrorheological dampers. Alternatively or additionally, the active vibration reduction device can be adapted to actively absorb vibrations of the distributor linkage. In contrast to vibration damping, vibration absorbing makes it possible to reduce linkage vibrations without requiring movement of the distributor linkage. Alternatively or additionally, the active vibration reduction device may be adapted to actively decouple the distributor linkage from an exciter component which excites the distributor linkage to vibrations. With active decoupling, for example, the decoupling properties of a decoupling device between the exciter component and the distributor linkage can be actively adapted using energy.

The vibration reduction device is preferably located between the linkage suspension and the distributor linkage. Furthermore, the vibration reduction device may be partially or fully integrated into the linkage suspension and/or distributor linkage.

In another preferred embodiment of the spraying device according to the invention, the active vibration reduction device has one or more counter-exciters which are arranged to excite the distributor linkage against the linkage vibrations. Accordingly, the one or more counter-exciters implement the active vibration damping of the linkage vibrations. Preferably, one or more counter-exciters shall comprise one or more hydraulic cylinders, in particular plunger cylinders. Preferably at least one hydraulic cylinder is aligned in the direction of travel and at least one hydraulic cylinder in the opposite direction. Alternatively, instead of two plunger cylinders, either a differential cylinder or a synchronous cylinder with two cylinder chambers each can be provided. Preferably, one or more counter-exciters are controlled via proportional pressure control valves.

The spraying device according to the invention is further developed in an advantageous way by the fact that the dispensing quantity controller is adapted to adjust the spray quantity of spray liquid at several, grouped or all spray elements independently of each other to the vibrations of the distributor linkage. This means, for example, that the dispensing quantity can be adapted individually on each dispensing element or the dispensing quantity can be adapted jointly on several grouped dispensing elements arranged along a part width of the distributor linkage. The independent adaptation of the dispensing quantity at each individual dispensing element leads to a particularly uniform dispensing of the spray liquid. If the dispensing quantity of several groups of dispensing elements can be adapted independently to the vibrations of the distributor linkage, the wiring and control effort is reduced, while at the same time a high regularity in the dispensing of the spray liquid can be achieved.

In addition, a spraying device according to the invention is preferred in which the dispensing quantity controller is arranged to implement the adaptation of the dispensing quantity of spray liquid of the individual, grouped or all dispensing elements by adapting the flow rate of spray liquid through the individual, grouped or all dispensing elements. The adaptation of the flow rate can include the setting of a concrete flow rate as well as the interruption and release of the flow through the dispensing elements. The adaption of the flow rate of spray liquid through the individual, grouped or all dispensing elements can, for example, be multi-stage or stageless.

In another preferred embodiment of the spraying device according to the invention, the dispensing quantity controller is arranged to adapt the dispensing quantity of spray liquid of the individual, grouped or all dispensing elements by adjusting the flow cross-section of the individual, grouped or all dispensing elements. The flow cross-section can be adjusted, for example, via an adjustable orifice. For example, an adjustable orifice can be used to adjust the diameter of a circular flow opening. Alternatively, the shape of a flow opening can be changed by partially or completely covering the flow opening through the orifice. If the dispensing elements are designed as spray nozzles, the adjustment of the flow cross-section can be achieved by adjusting the nozzle cross-section. In addition to spray nozzles in which the nozzle cross-section is adjustable, an adjustable orifice can be arranged in front of each spray nozzle or in front of each part width along which several spray nozzles are arranged.

A spraying device according to the invention is also preferred, in which the dispensing quantity controller is adapted to implement the adaptation of the dispensing quantity to spray liquid of the individual, grouped or all spray elements by a modulation method, in particular by pulse width frequency modulation, at the individual, grouped or all dispensing elements. By means of the modulation method, for example, high-frequency closing and opening of the individual, grouped or all dispensing elements can be implemented. For example, the modulation method can be carried out by modulating a control current or a control voltage, by means of which the state of the dispensing elements can be changed. The modulation method can be a pulse width modulation, a frequency modulation or a pulse width frequency modulation. Pulse width frequency modulation combines pulse width modulation and frequency modulation. Unlike pure pulse width modulation, the pulse frequency can be changed in addition to the pulse width. Preferably, the cycle duration of a switching cycle of a dispensing element is composed of a first period during which the dispensing element is open and a second period which follows directly after the first period or lies directly before the first period and during which the dispensing element is closed. With pulse width frequency modulation, the first time duration and/or the second time duration are variable, so that the cycle duration of a switching cycle and thus the pulse frequency are also variable. By combining the change of pulse width and pulse frequency, the spraying device is able, for example, to vary the dispensing quantity of spray liquid almost continuously at the individual, grouped or all dispensing elements. The spray pressure and/or droplet size remain essentially constant during pulse width frequency modulation. In addition, the high drop speed leads to a short drop flight time. This leads to a targeted application and at the same time to a strong reduction of drift.

A further advantage is a spray device according to the invention, in which the dispensing quantity controller is adapted to implement the adaptation of the dispensing quantity to spray liquid of the individual, grouped or all spray elements by pulse width modulation on the individual, grouped or all spray elements. By means of pulse width modulation, high-frequency closing and opening of the individual, grouped or all dispensing elements can be implemented. In addition, pulse width modulation can also be used to implement a multi-stage adaptation of the dispensing quantity to spray liquid of the individual, grouped or all spray elements. For example, pulse width modulation can be performed by pulsing a control current or a control voltage which can be used to change the state of the dispensing elements.

In another preferred embodiment the spraying device according to the invention comprises a detection device which is adapted to detect and/or determine vibrations of the distributor linkage. The detection device is preferably designed to detect and/or determine horizontal and/or vertical vibrations of the distributor linkage. Preferably, the detection device is designed to detect and/or determine the amplitude and/or frequency of horizontal linkage vibrations directed in the direction of travel and counter to the direction of travel. Furthermore, the detection device is preferably adapted to detect and/or determine elastic vibrations and/or rigid-body vibrations of the distributor linkage. In particular, the detection device comprises a path sensor which is arranged on the linkage suspension and is used to limit the stroke of the counter-exciters during active vibration damping.

In another preferred embodiment of the spraying device according to the invention, the detection device is arranged to provide the vibration reduction device and/or the dispensing quantity controller with information on the detected vibrations of the distributor linkage. The actual value of the vibration state can be determined by providing information on the detected vibrations of the distributor linkage for the vibration reduction device and/or the dispensing quantity controller. The detection device is, for example, adapted to detect the speed at several positions of the distributor linkage or at individual, grouped or all dispensing elements. The detection device is also designed to detect and/or determine the forward speed of the spraying device or the forward speed of the agricultural sprayer. By comparing the speeds at one or more positions of the distributor linkage or the dispensing elements with the driving speed of the dispending elements or the agricultural sprayer, the linkage vibration at the corresponding positions can be derived. The detected linkage vibrations can also be recorded, so that expected linkage vibrations can be predicted using recorded vibrations. In this way, a particularly effective vibration reduction and dispensing quantity control can be implemented.

In another preferred embodiment of the spraying device according to the invention, the detection device for detecting vibrations of the distributor linkage is adapted to detect and/or evaluate a condition of the spraying device and/or the agricultural sprayer causing vibrations of the linkage. For example, movements or vibrations on components of the spraying device and/or the agricultural sprayer can be determined and used to reduce linkage vibrations and/or to control the dispensing quantity of the dispensing elements. Furthermore, the acceleration state of the spraying device and/or agricultural sprayer and/or the deflection and/or the forces on the wheels or suspensions of the agricultural sprayer can be detected in order to derive the expected linkage vibrations from these data.

In a further development of the spraying device according to the invention, the detection device has at least two sensors which are arranged at a distance from one another on the distributor linkage and are adapted to detect and/or determine linkage movements. For example, the sensors can detect and/or determine the linkage position, the linkage speed and/or the linkage acceleration. Preferably at least one or only one sensor is arranged on each of the two lateral linkages of the distributor linkage.

In a further embodiment of the spraying device according to the invention, the distributor linkage comprises two lateral linkages which extend in opposite directions during operation of the spraying device, a plurality of sensors being arranged on each linkage of the distributor linkage, which sensors are arranged at a distance from one another and are adapted to detect and/or determine linkage movements. With an increasing number of sensors, the vibration state of the distributor linkage can be determined with increasing precision. The more precisely the linkage vibrations are detected, the more effectively the vibrations of the distributor linkage can be reduced and the more precisely the dispensing quantity can be adjusted at the dispensing elements.

In a further development of the spraying device according to the invention, the detection device has a number of sensors, the number and arrangement of the sensors on the distributor linkage permitting the determination of at least the horizontal deflection and/or speed of the dispensing elements arranged on the distributor linkage and caused by linkage vibrations. In principle, the number of sensors can fall below or exceed the number of dispensing elements arranged on the distributor linkage or correspond to the number of dispensing elements. Taking into account the vibration characteristics of the distributor linkage, the vibration behaviour in the area of the dispensing elements can be derived with just a small number of sensors arranged at suitable positions on the distributor linkage.

In a different embodiment of the spraying device according to the invention, the detection device comprises a plurality of sensors which are arranged to detect and/or determine linkage movements, a sensor being arranged in the area of each dispensing element or on each dispensing element. As the linkage movements in the area of the dispensing elements or the movements of the dispensing elements are known, a particularly precise adaptation of the dispensing quantity to the individual dispensing elements can be carried out. Preferably, a sensor and a dispensing element are each part of an intelligent functional unit, in which the dispensing quantity at the dispensing element is controlled depending on the detected data of the sensor.

In a preferred embodiment of the spraying device according to the invention the sensors are formed as acceleration sensors and adapted to detect the linkage acceleration and/or the acceleration of the dispensing elements. The acceleration sensors are preferably adapted to detect the linkage acceleration and/or the acceleration of the dispensing elements in the horizontal and/or vertical direction. Alternatively, the one or more sensors can also be formed as speed sensors, path sensors or radar sensors. In addition, the one or more sensors can also be designed as strain gages or a camera.

In addition, a spraying device according to the invention is preferred in which the detection device is adapted to detect a cornering and the dispensing quantity controller is adapted to adapt the dispensing quantity of spray liquid of individual, grouped or all spray elements to the detected cornering movement. During cornering, different speeds occur at the dispensing elements due to the different curve radii on which the dispensing elements move. In order to be able to compensate an overdosage and underdosage of the sprayed liquid in this case as well, it is necessary on the one hand to adapt the dispensing quantity to the different curve radii of the dispensing elements and on the other hand to adapt the dispensing quantity to the additionally occurring linkage vibrations. If both the cornering and the vibration condition of the distributor linkage are taken into account when adjusting the dispensing quantity of spray liquid, an extremely uniform dispensing of spray liquid can be achieved even during cornering. The cornering can be determined by various sensors or sensor combinations, such as rotation rate sensor and/or steering angle sensor and/or speed sensor and/or GPS sensor and/or acceleration sensor. The sensors can be located on the basic unit, a tractor and/or the linkage.

The object underlying the invention is further solved by an agricultural sprayer of the type described above, the spraying device being of one of the types described above. With regard to the advantages and modifications of the agricultural sprayer according to the invention, reference is made to the advantages and modifications of the spraying device according to the invention.

Further details of the invention can be found in the description of the Figure and the drawings.

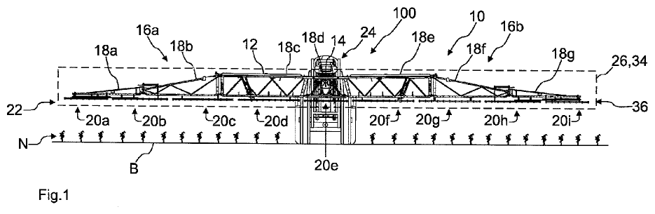

FIG. 1 shows an embodiment of an agricultural sprayer according to the invention in a rear view;

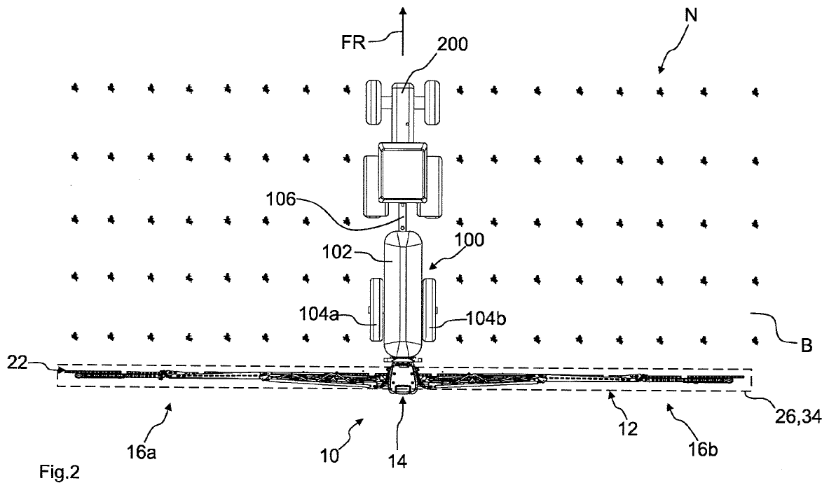

FIG. 2 shows the agricultural sprayer shown in FIG. 1 in a plan view;

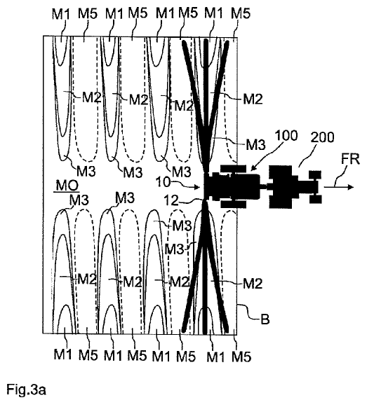

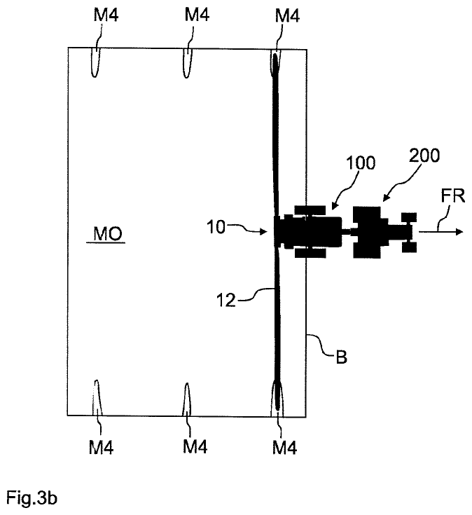

FIG. 3a shows a dispensing operation without vibration reduction and without dispensing quantity control;

FIG. 3b shows a dispensing operation with vibration reduction and dispensing quantity control;

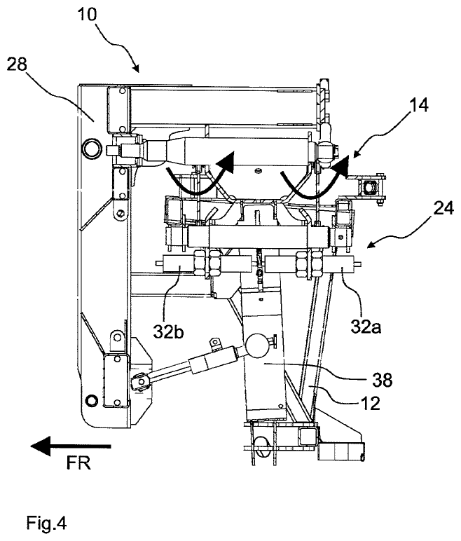

FIG. 4 shows the linkage suspension of a spraying device according to the invention; and

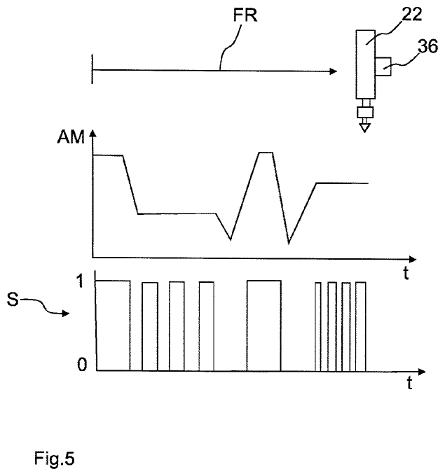

FIG. 5 shows a dispensing element of a spraying device according to the invention while adjusting the dispensing quantity to the spray liquid.

FIG. 1 shows an agricultural sprayer 100 designed as a field sprayer. The agricultural sprayer 100 has a spraying device 10 with a distributor linkage 12. The distributor linkage 12 is connected to a suspension frame by means of a linkage suspension 14, whereby the linkage suspension 14 permits a small relative movement between the distributor linkage 12 and the suspension frame. Furthermore, the distributor linkage 12 comprises two lateral arms 16a, 16b, which extend in opposite directions during operation of the spraying device 10.

The first arms 16a comprises a total of three linkage segments 18a-18c that can be swivelled to each other. The second arm 16b comprises a total of three linkage segments 18e-18g that can be swivelled to each other. The internal linkage segment 18c of the first arm 16a and the internal linkage segment 18e of the second arm 16b are each pivotably connected to the central linkage segment 18d of the distributor linkage 12. The linkage segments 18a-18g are adapted such that they can be swivelled in such a way that the distributor linkage 12 can be brought into an unfolded transport position of maximum 3 m width and an unfolded working position of up to 50 m and more.

On the distributor linkage 12 a plurality of dispensing elements 22 designed as spray nozzles are arranged for dispensing a spray liquid, wherein the dispensing elements 22 are each assigned to a group 20a-20i of dispensing elements 22. The dispensing elements 22 of a group 20a-20i of dispensing elements 22 extend over a part width of the distributor linkage 12, whereby a group 20a-20i for example comprises between 5 and 15 dispensing elements 22.

The spraying device 10 also has an active vibration reduction device 24, which is designed to actively reduce horizontal and vertical elastic vibrations of the distributor linkage 12 and horizontal and vertical rigid body vibrations of the distributor linkage 12.

The active vibration reduction device 24 is also adapted to implement active vibration reduction by actively absorbing the vibrations of the distributor linkage 12. For this purpose the vibration reduction device 24 has a plurality of counter exciters (see FIG. 4) which are adapted to excite the distributor linkage 12 against the linkage vibrations.

In addition, the spraying device 10 comprises a dispensing quantity controller 26 which is adapted to adjust the dispensing quantity of spray liquid of the dispensing elements 22 independently of one another to the vibrations of the distributor linkage 12. The dispensing quantity of the spray liquid of the dispensing elements 22 is adapted to the vibrations of the distributor linkage 12 by adapting the dispensing quantity of the spray liquid of the dispensing elements 22 to the speed of the respective dispensing element 22 or the linkage section of the distributor linkage 12 on which the respective dispensing element 22 is arranged.

In addition, the spraying device 10 comprises a detection device 34 which is adapted to detect vibrations of the distributor linkage 12. The detection device can detect 34 horizontal and vertical elastic oscillations as well as horizontal and vertical rigid body vibrations of the distributor linkage 12. The detection device 34 comprises a plurality of sensors 36 adapted as acceleration sensors, which are designed to detect the linkage acceleration in the direction of travel, against the direction of travel and in the vertical direction. A sensor 36 is arranged on each dispensing element 22 or in the area of each dispensing element 22, whereby a sensor 36 and a dispensing element 22 are each part of an intelligent functional unit, in which the dispensing quantity on the dispensing element 22 is controlled as a function of the detected acceleration data of the sensor 36.

Furthermore, the detection device 34 is adapted via the sensors 36 to detect a cornering, wherein the dispensing quantity controller 26 is adapted to adapt the dispensing quantity of spray liquid of the dispensing elements 22 to the detected curve. During cornering, the dispensing quantity of the spray liquid of the dispensing elements 22 is adapted to the cornering and to the detected linkage vibrations.

FIG. 2 shows that the agricultural sprayer 100 is pulled over a crop N on soil B by a tractor 200. The agricultural sprayer 100 comprises a storage tank 102 for storing the spray liquid to be dispensed. The storage tank 102 is connected to the spraying device 10 for dispensing the spray liquid.

One wheel 104a, 104b is arranged on each side of the storage tank 102. The storage tank 102 is supported by a supporting frame of the agricultural sprayer 100, whereby the supporting frame of the agricultural sprayer 100 is connected in a front area with a drawbar 106, via which the coupling with the tractor 200 is moved. In the rear area the supporting frame of the agricultural sprayer 100 is connected to the linkage suspension 14 for the distributor linkage 12. The distributor linkage 12 extends transversely to the direction of travel FR of the agricultural sprayer 100.

FIG. 3a shows a spraying device 10 during the execution of a dispensing operation. The spraying device 10 is in a state in which neither an active reduction of the vibrations of the distributor linkage 12 nor an adjustment of the dispensing quantity to spray liquid of the dispensing elements arranged on the distributor linkage takes place.

For example, the spraying device 10 does not include an active vibration reduction device, a dispensing quantity controller, or the active vibration reduction device and the dispensing quantity controller are disabled.

Due to the lack of active vibration reduction and the lack of adaptation of the dispensing quantity of spray liquid of the dispensing elements to the vibrations of the distributor linkage 12, considerable irregularities occur during the dispensing of the spray liquid on the soil B. The peripheral areas in which the dispensing quantity M1 of spray liquid significantly exceeds the intended dispensing quantity M0 are surrounded by a further area in which the dispensing quantity M2 of spray liquid still significantly exceeds the intended dispensing quantity M0 of spray liquid, but to a lesser extent than the dispensing quantity M1 of spray liquid. The areas in which the dispensing quantity M2 of spray liquid significantly exceeds the intended dispensing quantity M0 are surrounded by a further area in which the dispensing quantity M3 of spray liquid continues to exceed the intended dispensing quantity M0 in a yield-reducing manner but to a lesser extent than the dispensing quantity M2 of spray liquid.

Correspondingly, there are areas M5 in which the intended dispensing quantity M0 is undershot, whereby local deviations within the peripheral area M5 are possible. Thus the dispensing quantities, especially in the outer peripheral area, can deviate further from the desired dispensing quantity than in the vicinity of the centre. The reason for the deviations is a too long stay of the linkage in the areas M1-M3, which leads to a too large dispensing quantity in these areas and a too low stay in the area M5, which leads to a too low dispensing quantity in this area compared to the desired dispensing quantity M0.

The irregularities in the spray agent distribution lead to considerable yield losses and must therefore be avoided at all costs.

FIG. 3b shows a spraying device 10 during the execution of a dispensing operation. This results in both an active reduction of the vibrations of the distributor linkage 12 and an adaptation of the dispensing quantity to the spray liquid of the dispensing elements arranged on the distributor linkage.

For the active reduction of the vibrations of the distributor linkage 12 and for the adaptation of the dispensing quantity of spray liquid of the dispensing elements arranged on the distributor linkage, the spraying device 10 uses a detection device which is adapted to provide information on the detected vibrations of the distributor linkage 12 to a vibration reduction device and to a dispensing quantity controller. For example, the spraying device 10 can be designed according to the spraying device 10 shown in FIGS. 1 and 2.

By providing information on the detected vibrations of the distributor linkage 12 for the vibration reduction device and the dispensing quantity controller, an actual value of the vibration state can be determined. On the basis of the vibration state, the vibrations of the distributor linkage 12 can then be effectively and actively reduced and a precise adjustment of the dispensing quantity to the spray liquid of the dispensing elements can be carried out.

Due to the active reduction of the vibrations of the distributor linkage 12 as well as the adaptation of the dispensing quantity to the spray liquid of the dispensing elements, the amount of spray liquid M4 applied in the peripheral areas only slightly exceeds the intended dispensing quantity M0, so that no significant loss of yield occurs due to local over- or underdosing of the spray liquid. In the remaining areas of soil B, the dispensing quantity M0 of spray liquid corresponds to the intended dispensing quantity.

FIG. 4 shows a linkage suspension 14 of a spraying device 10 designed as a pendulum suspension. The distributor linkage 12 is connected to a suspension frame 28 via an intermediate frame 38 by means of the linkage suspension 14. The linkage suspension 14, which is designed as a pendulum suspension, provides vertical guidance of the distributor linkage 12.

The active vibration reduction device 24 has two counter exciters 32a, 32b, which are adapted to excite the distributor linkage 12 against the linkage vibrations. The counter exciters 32a, 32b are each designed as hydraulic cylinders, namely as plunger cylinders, whereby the counter exciter 32a is aligned in the direction of travel FR and the counter exciter 32b in the opposite direction to the direction of travel FR. The counter exciters 32a and 32b are controlled, for example, via proportional pressure control valves.

The detection device of the shown spraying device 10 can also have a path sensor which is arranged on the linkage suspension 14 and is used to limit the stroke of the counter exciters 32a, 32b during active vibration damping.

FIG. 5 shows a dispensing element 22 designed as a spray nozzle, which was moved in the direction of travel FR. For example, individual or all of the dispensing elements 22 of the spraying device 10 shown in FIGS. 1 and 2 can be designed according to this dispensing element 22.

A sensor 36 designed as an acceleration sensor is arranged on the dispensing element 22. A dispensing quantity controller is arranged to implement the adaptation of the dispensing quantity AM to the spray liquid of the dispensing element 22 by adapting the flow to spray liquid through the dispensing element 22. In concrete terms, the adjustment of the dispensing quantity AM to the spray liquid of the dispensing element 22 is implemented by pulse width modulation on the dispensing element 22. Pulse width modulation permits high-frequency closing and opening of the dispensing element 22. The switching state S of the dispensing element 22 over time t is also shown. The pulse width modulation causes the dispensing element 22 to switch several times between the open state 1 and the closed state 0. Depending on how long the dispensing element 22 is open and closed, a corresponding dispensing quantity AM is achieved.

The pulse width modulation shown is a pulse width frequency modulation. In addition to the pulse width, the pulse frequency is also changed. The cycle duration of a switching cycle of the dispensing element 22 consists of a first period during which the dispensing element 22 is open and the switching state “1” is set, and a second period which follows directly after the first period and during which the dispensing element 22 is closed and the switching state “0” is set. It is shown that the first period during which the dispensing element 22 is open and the second period during which the dispensing element 22 is closed vary so that a precise adjustment of the dispensing quantity can be made.

Alternatively or additionally, the dispensing quantity controller may be adapted to adjust the dispensing quantity AM to the spray liquid of the dispensing element 22 by adjusting the flow cross-section of the dispensing element 22, whereby the flow cross-section can be adjusted, for example, by means of an adjustable orifice.

The dispensing quantity AM of the spray liquid of the dispensing element 22 can thus be adapted to the speed of the dispensing element 22, whereby the speed of the dispensing element 22 is detected by the sensor 36. By adjusting the AM dispensing quantity to the spray liquid, local over-dosage and under-dosage of the spray liquid caused by linkage vibrations can be effectively compensated.

### LIST OF REFERENCE NUMERALS

10 spraying device

12 distributor linkage

14 linkage suspension

16a, 16b arms

18a-18g linkage segments

20a-20i groups of dispensing elements

22 dispensing elements

24 vibration reduction device

26 dispensing quantity controller

28 suspension frame

32a, 32b counter-exciter

34 detection device

36 sensors

38 intermediate frame

100 agricultural sprayer

102 storage tank

104a, 104b wheels

106 drawbar

200 tractor

B soil

N crop

AM dispensing quantity

M0-M4 total spray liquid dispensing quantity

t time

S switching state

FR direction of travel

1. Spraying device for an agricultural sprayer, comprising
a distributor linkage on which a plurality of dispensing elements are arranged for dispensing a spray liquid;
an active vibration reduction device which is adapted to actively reduce vibrations of the distributor linkage; and
a dispensing quantity controller configured to adapt a dispensing quantity of spray liquid of individual, grouped or all of the dispensing elements to vibrations of the distributor linkage.

2. The spraying device according to claim 1,
wherein the active vibration reduction device is adapted to actively reduce elastic vibrations of the distributor linkage or rigid body vibrations of the distributor linkage.

3. The spraying device according to claim 1, wherein the active vibration reduction device is adapted to reduce horizontal or vertical linkage vibrations.

4. The spraying device according to claim 1, wherein the active vibration reduction device is configured:
to actively dampen vibrations of the distributor linkage;
to actively absorb vibrations of the distributor linkage; or
to actively decouple the distributor linkage from an exciter component which excites the distributor linkage to vibrations.

5. The spraying device according to claim 1, wherein the active vibration reduction device comprises one or more counter-exciters arranged to excite the distributor linkage against the linkage vibrations.

6. The spraying device according to claim 1, wherein the dispensing quantity controller is adapted to adjust the dispensing quantity of spray liquid on a plurality of, grouped or all of the dispensing elements independently of one another to the vibrations of the distributor linkage.

7. The spraying device according to claim 1, wherein the dispensing quantity controller is adapted to convert the adaptation of the dispensing quantity to spray liquid of the individual, grouped or all of the dispensing elements by adapting the flow of spray liquid through the individual, grouped or all of the dispensing elements.

8. The spraying device according to claim 1, wherein the dispensing quantity controller is adapted to convert the adaptation of the dispensing quantity to spray liquid of the individual, grouped or all of the dispensing elements by adapting the flow cross-section of the individual, grouped or all of the dispensing elements.

9. The spraying device according to claim 1, wherein the dispensing quantity controller is adapted to convert the adaptation of the dispensing quantity to spray liquid of the individual, grouped or all of the dispensing elements by a modulation method, in particular by pulse width frequency modulation, at the individual, grouped or all of the dispensing elements.

10. The spraying device according to claim 1, further including a detection device which is adapted to detect or determine vibrations of the distributor linkage.

11. The spraying device according to claim 10, wherein the detection device is adapted to provide information to the vibration reducing means or the dispensing quantity controller about the detected vibrations of the distributor linkage.

12. The spraying device according to claim 10, wherein the detection device for detecting vibrations of the distributor linkage is adapted to detect or evaluate a condition of the spraying devices or the agricultural sprayer causing linkage vibrations.

13. The spraying device according to claim 10, wherein the detection device comprises at least two sensors which are arranged at a distance from one another on the distributor linkage and are suitable for detecting or determining linkage movements.

14. The spraying device according to claim 10, the distributor linkage comprising two lateral arms which extend in opposite directions during operation of the spraying device, wherein a plurality of sensors are arranged on each arm of the distributor linkage, which sensors are arranged at a distance from one another and are suitable for detecting or determining linkage movements.

15. The spraying device according to claim 10, wherein the detection device has a number of sensors, the number and arrangement of the sensors on the distributor linkage permit the determination of at least the horizontal deflection or speed of the dispensing elements arranged on the distributor linkage and caused by linkage vibrations.

16. The spraying device according to claim 10, wherein the detection device comprises a plurality of sensors which are suitable for detecting or determining linkage movements, a sensor being arranged in the area of each dispensing element or on each dispensing element.

17. The spraying device according to claim 13, wherein the sensors are formed as acceleration sensors and are arranged to detect the linkage acceleration or the acceleration of the dispensing elements.

18. The spraying device according to claim 10, wherein the detecting device is adapted to detect a cornering and the dispensing quantity controller is adapted to adapt the dispensing quantity to spray liquid of individual, grouped or all of the dispensing elements of the detected curves.

19. Agricultural sprayer, comprising:
a storage tank for storing spray liquid; and
a spraying device connected to the storage tank for dispensing the spray liquid;
wherein the spraying device comprises:
a distributor linkage on which a plurality of dispensing elements are arranged for dispensing a spray liquid;
an active vibration reduction device which is adapted to actively reduce vibrations of the distributor linkage; and
a dispensing quantity controller configured to adapt a dispensing quantity of spray liquid of individual, grouped or all of the dispensing elements to vibrations of the distributor linkage.
